(19) United States
(12) Patent Application Publication
(10) Pub. No.: US 2022/0176821 A1
(43) Pub. Date: Jun. 9, 2022

(54) DISPLAY WITH UNDERLYING DECORATIVE LAYER

(71) Applicant: Corning Incorporated, Corning, NY (US)

(72) Inventors: Shandon Dee Hart, Elmira, NY (US); Frank Brock Riggs, Corning, NY (US)

(21) Appl. No.: 17/605,745

(22) PCT Filed: Apr. 17, 2020
(86) PCT No.: PCT/US2020/028657

§ 371 Date: Oct. 22, 2021

Related U.S. Application Data
(60) Provisional application No. 62/840,249, filed on Apr. 29, 2019.

(51) Int. Cl. B60K 37/02

(52) U.S. Cl. CPC B60K 37/02; B60K 2370/688; B60K 2370/39; B60Y 2200/11; B60K 2370/349; B60K 2370/23; B60K 2370/1523

(57) ABSTRACT

A system such as a vehicle, an appliance, or a mobile phone can include an assembly featuring a decorative layer and a transparent display module. The decorative layer can include ink applied to a substrate. The transparent display module can be mounted to the decorative layer and include an array of pixels disposed behind an outer cover glass. The assembly can be configured such that when the display module is in a first mode, the decorative layer is visible from the cover glass and through the pixel array.

### CROSS-REFERENCE TO RELATED APPLICATIONS

This application claims the benefit of priority under 35 U.S.C. § 119 of U.S. Provisional Application Ser. No. 62/840,249 filed on Apr. 29, 2019 the content of which is relied upon and incorporated herein by reference in its entirety.

### BACKGROUND

### Field of the Disclosure

Among other things, the present disclosure relates to an electronic display. The display can be located in a vehicle.

### Description of Related Art

Vehicles can include a dashboard integrating one or more electronic displays such as liquid crystal displays (LCDs), organic light emitting diode (OLED) displays, waveguide displays, etc. When active, a display can present graphics for enabling user interaction with various vehicle systems. For example, a display can present graphics enabling user control of air conditioning, audio, autonomous driving, or telecommunications. When inactive, a display can present a black screen. The black screen may undesirably contrast with the visual aesthetics of the surrounding dashboard.

A technique called deadfronting can be used to harmonize (i.e., aesthetically blend) an inactive display with surrounding dashboard. Historically, deadfront has involved surrounding the display with black material (e.g., black plastic bezels), which is intended to blend seamlessly with the inactive display. However, it is difficult to achieve a truly seamless blending between the border and display area. In another form of deadfront, a metallic or textured surface is disposed above a display. When the display is inactive, the metallic or textured surface may be visible instead of a black screen. Because display light passes through the metallic or textured surface before reaching a viewer, the display may exhibit poor image quality.

### SUMMARY

Features disclosed herein enable seamless aesthetic integration of a high quality display within a vehicle dashboard or other support. The display (also called a “display unit”) can be transparent and integrated into vehicle interior design in a manner that is aesthetically pleasing, offers ergonomic enhancements, and improves safety through ease of use and visibility.

According to various embodiments, a transparent display including cover glass, a touch screen, a TFT panel, and a pixelated display (e.g., an OLED display) can be placed above an underlying support surface such as a metal surface, a wood grain surface, a black or other colored surface, or any other type of auto interior material. The underlying surface may include a glass material with a decorative ink layer, which may simulate a wood grain, metal, or other kind of surface and may include natural wood, metal, and other materials.

When the display is in a first (e.g., active) mode, light from the active pixels may present the graphic intended for presentation on the display. When the display is in a second (e.g., inactive) mode, only the underlying surface (e.g., the black or wood-grain surface) may be visible to the user. An optical surface can be applied to the cover glass to assist in blending the display with the surrounding surfaces.

An assembly can include: a decorative layer, a transparent display module, and a cover glass. The decorative layer can include a substrate panel. The transparent display module can be mounted to the decorative layer and include a glass substrate. The assembly can be configured such that when the display module is in an inactive state, the decorative layer is visible through the glass substrate. The cover glass can be mounted to the display module. At least one of the cover glass and the glass substrate can include an optical coating or texture that modifies light transmittance and/or light reflectance in a manner that reduces visibility of the display module, causing an area within the display module to have an appearance that is similar to the decorative layer.

An assembly can include: a decorative layer comprising ink applied to a substrate; a transparent display module mounted to the decorative layer and comprising an array of pixels and an outer cover glass, the pixel array being disposed between the decorative layer and the cover glass. The assembly can be configured such that when the display module is in a first mode, the decorative layer is visible from the cover glass and through the pixel array.

A system, such as a vehicle or a mobile phone can include: a transparent display module comprising an array of pixels and a glass substrate; a decorative layer mounted to the display module and comprising ink applied to a substrate, the decorative layer being disposed underneath the pixel array. The system can be configured such that when the display module is in a first mode, the decorative layer is visible through the glass substrate of the display module and through the pixel array.

An assembly can include: a decorative layer and a transparent display module. The decorative layer can include a substrate panel. The transparent display module can be mounted to the decorative layer and include a glass substrate. The assembly can be configured such that when the display module is in an inactive state, the decorative layer is visible through the glass substrate. The glass substrate can include an optical coating or texture that modifies light transmittance and/or light reflectance in a manner that reduces visibility of the display module, causing an area within the display module to have an appearance that is similar to the decorative layer.

### BRIEF DESCRIPTION OF DRAWINGS

The above summary and the below detailed description of illustrative embodiments may be read in conjunction with the appended Figures. The Figures show some of the illustrative embodiments discussed herein. As further explained below, the claims are not limited to the illustrative embodiments. For clarity and ease of reading, Figures may omit views of certain features.

FIG. 1 schematically illustrates an exemplary vehicle dashboard having one or more display modules in an active mode.

FIG. 2 schematically illustrates the exemplary vehicle dashboard of FIG. 1 where the one or more display modules are in an inactive mode.

FIG. 3A schematically illustrates an exemplary active display module mounted to a wall.

FIG. 3B schematically illustrates the exemplary display module of FIG. 3A while inactive.

FIG. 3C schematically illustrates an exemplary active display module of a mobile device.

FIG. 3D schematically illustrates the exemplary display module of FIG. 3C while inactive.

FIG. 4A-7C are block diagrams of various exemplary embodiments of a display unit.

FIGS. 8A and 8B are block diagrams of exemplary methods of controlling a display unit.

FIG. 9 is a block diagram of an exemplary processing system for performing the methods of FIGS. 8A and 8B.

### DETAILED DESCRIPTION

The present application discloses illustrative (i.e., example) embodiments. The claimed inventions are not limited to the illustrative embodiments. Therefore, many implementations of the claims will be different than the illustrative embodiments. Various modifications can be made to the claimed inventions without departing from the spirit and scope of the disclosure. The claims are intended to cover implementations with such modifications.

At times, the present application uses directional terms (e.g., front, back, top, bottom, left, right, etc.) to give the reader context when viewing the Figures. The claimed inventions, however, are not limited to the orientations shown in the Figures. Any absolute term (e.g., high, low, etc.) can be understood and disclosing a corresponding relative term (e.g., higher, lower, etc.).

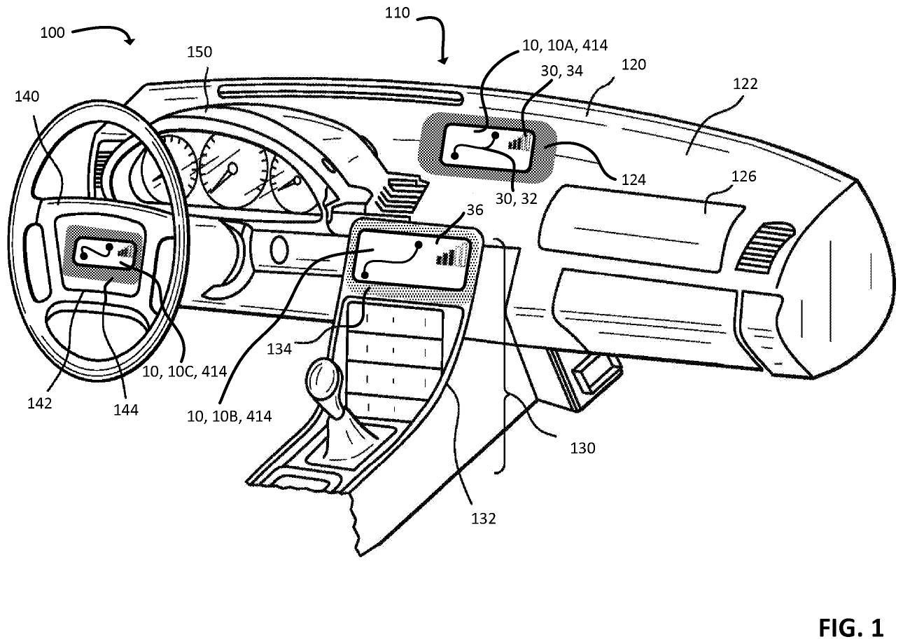

Referring to FIG. 1, a vehicle 100 (also called a system) can include a dashboard 110 (also called a support) for receiving inputs from a user (e.g., a driver) and for displaying information to the user. Dashboard 110 can include a main console 120, a center or secondary console 130, a steering wheel 140 (i.e., a user input device), and an instrument cluster 150 (i.e., a gauge cluster). Main console 120 can include an outer body 122 (also called an outer panel or support) mounting a first display unit 10, 10A and an airbag 126. Center console 130 can include an outer body 132 (also called an outer panel or support) mounting a second display unit 10, 10B. Steering wheel 140 can include an outer body 142 (also called an outer support) mounting a third display unit 10, 10C. Although shown as a car, vehicle 100 can be an airplane, a boat, a train, an all-terrain-vehicle, and so on.

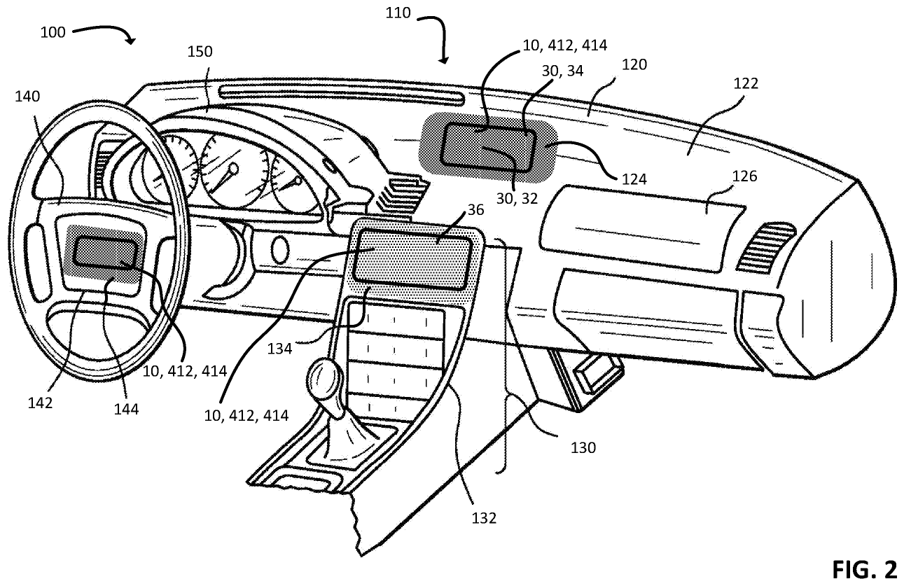

Each outer body 122, 132, 142 can respectively include an outer surface 124, 134, 144 with a visual aesthetic. In FIGS. 1 and 2, the stippling patterns represent the visual aesthetics. Examples of visual aesthetics include a wood-grain visual aesthetic, a metallic visual aesthetic, a leather visual aesthetic, a piano black (or other color) visual aesthetic, and the like. The visual aesthetics can be simulated with synthetic treatments (e.g., ink applied to glass to imitate wood-grain). The visual aesthetics can at least partially result from the presence of the corresponding material (e.g., authentic wood, metal, leather, etc.). Any of the visual aesthetics can be glossy or matte. FIG. 1 shows the visual aesthetics as occupying the entire surface area (i.e., at least a portion of) surrounding the display units 10, 10A, 10B, 10C. In some embodiments, the visual aesthetics may be continuous across each outer body 122, 132, 142.

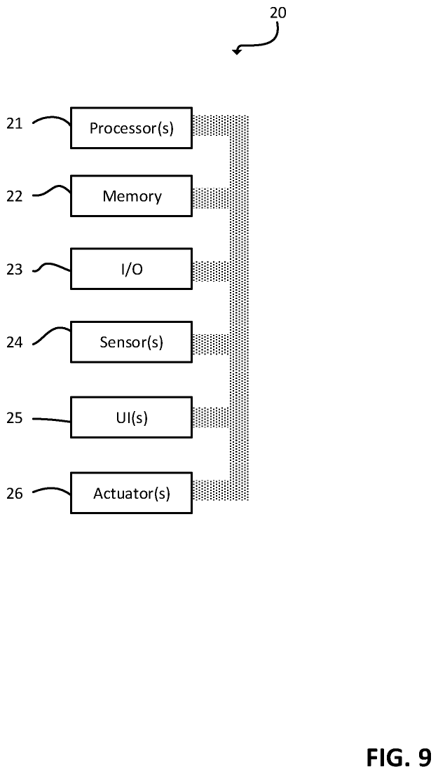

When the present disclosure refers to “display unit 10”, such a reference can be to any (e.g., all) of the display units discussed herein. Each display unit 10 can include a display module 414 (e.g., LCD, OLED, LED, microLED, and/or QLED display module) configured to present (i.e., display) graphics by controlling an internal pixel array. Display unit 10 can be configured for wired and/or wireless communication with a processing system 20 including one or more processors and memory. Processing system 20 can instruct display unit 10 to control the pixel array to produce a particular pattern, thus causing display module 414 to present a desired graphic (e.g., an image, a video, a homescreen, a webpage, etc.). Processing system 20 is further discussed below with reference to FIG. 9.

Display module 414 can be configured to occupy a first (e.g., active or ON) mode and a second (e.g., inactive, OFF, and/or passive) mode. While in the first mode, display module 414 can actively transmit light toward the user (e.g., the driver behind steering wheel 140) and/or actively control the pixel array to modify the color light emissions. While in the second mode, display module 414 can refrain from actively transmitting light toward the user and/or actively controlling light emitted toward the user. Light, however, may still flow through display module 414 during the second mode for reasons discussed below. In some embodiments, display module 414 can be configured to occlude view of an inner decorative layer during the first mode and facilitate view of the inner decorative layer during the second mode.

Throughout the Figures, a display module 414 in the first mode is shown as presenting the same graphic 30 including a curved route graphic 32 rendered by a navigation program running on the processing system 20 and a signal strength indicator 34 rendered by a telematics program running on processing system 20. In some embodiments, pixels mapping to leftover display area 36 are actively controlled to be a solid color (e.g., white, black, gray). In other embodiments, pixels in the array mapping to leftover display area 36 are off (e.g., transparent). Although pixels of display module 414 can be disposed in a layer directly attached to decorative layer 412 (discussed below), other embodiments of display module 414 can be projection based where a light source is disposed at an external location.

Referring to FIGS. 1 and 2, display module 414 can be transparent (e.g., exhibits transmittance over 40%) and disposed above a decorative layer 412 aesthetically matching the visual aesthetic of the surrounding surface 124, 134, 144. For example, if the visual aesthetic of the surrounding surface is a glossy wood-grain, then the decorative layer 412 can exhibit a glossy wood-grain visual aesthetic and if the visual aesthetic of the surrounding surface is a brushed metal, then the decorative layer 412 can exhibit a matte metallic visual aesthetic. When display module 414 is in the second (e.g., inactive) mode, the decorative layer 412 can be visible through the transparent display module 414. In some embodiments, occlusion can occur when the transmittance of display module 414 is at least 20, 30, 40, 50, 60, or 70% less than the transmittance of display module 414 when transparent.

FIG. 2 illustrates display units 10A, 10B, 10C each having an inactive display module 414. A decorative layer 412 is visible through each display module 414. As indicated with the common stippling patterns, each decorative layer 412 has a visual aesthetic matching the visual aesthetic of the surrounding outer surface 124, 134, 144. As a result, each display unit 10 produces a desirable deadfront effect wherein display unit 10 visually blends with outer bodies 122, 132, 142. Display unit 10 can include a transparent frame such that the perimeter outline of display unit 10 (shown as black rectangles in FIG. 2) disappears.

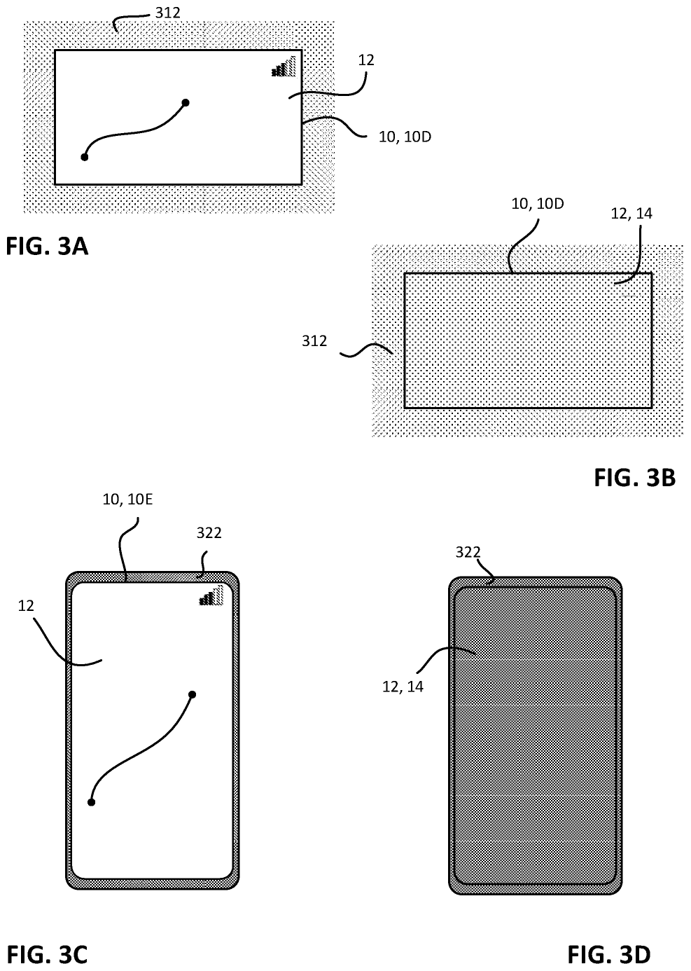

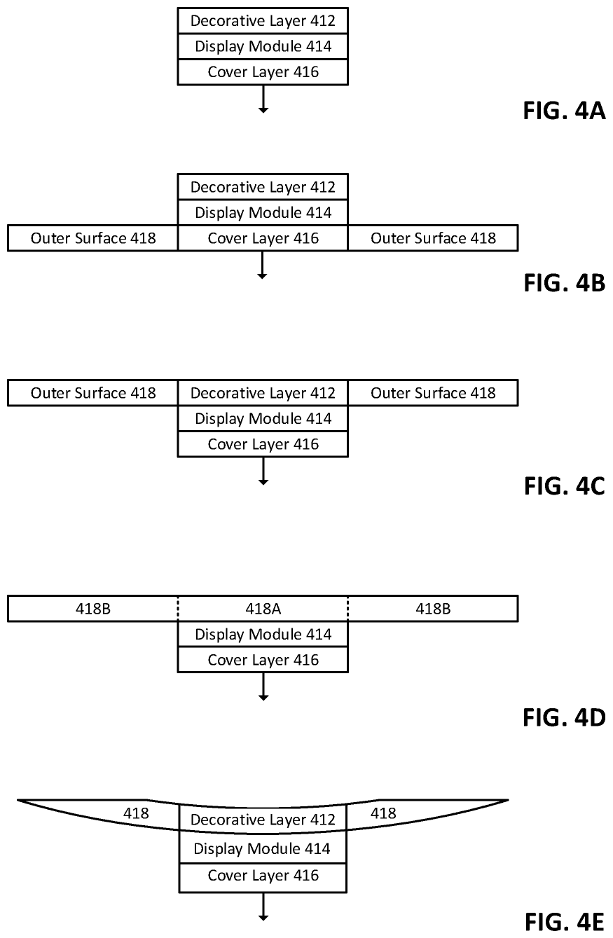

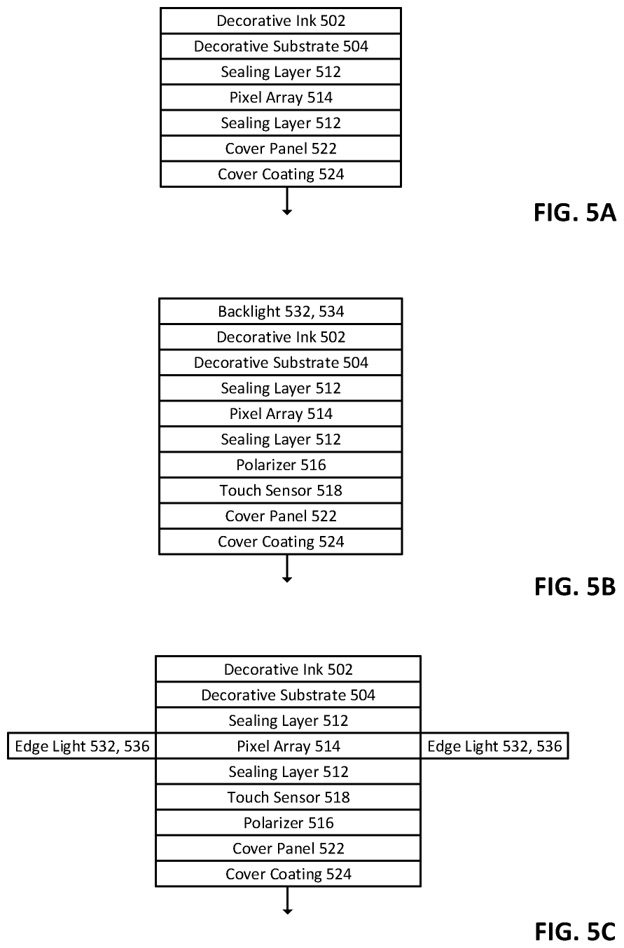

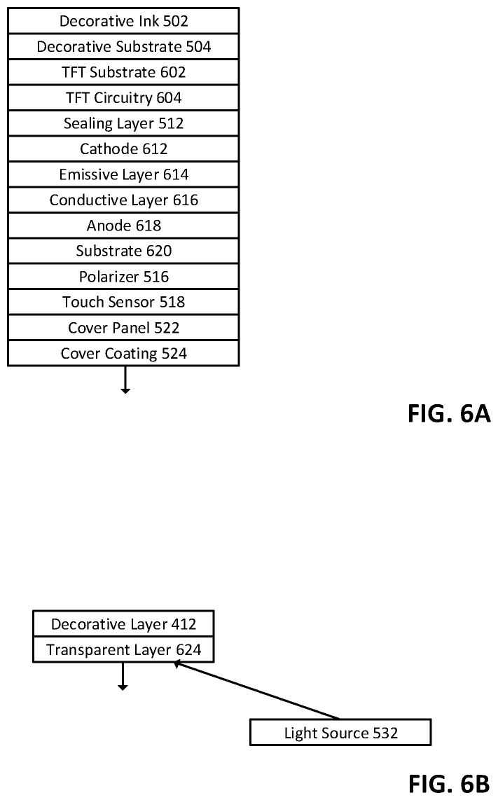

The technology disclosed herein is desirable in the context of a vehicle, but may be applied in any display context. In FIG. 3A, display unit 10, 10D is a television mounted on a wall 312 (i.e., an outer surface). The active pixel array of display module 414 is transmitting (e.g., reflecting, refracting, internally generating) light forming graphic 30 and occluding (e.g., substantially blocking) a view of decorative layer 412. In FIG. 3B, decorative layer 412 is visible through the inactive display module 414 such that display unit 10 produces a deadfront effect against wall 312. Similarly, FIG. 3C shows display unit 10, 10E as a being an aspect of a mobile device and being surrounded by bezels 322 (i.e., an outer surface). In FIG. 3D, decorative layer 412 is visible through inactive and transparent display module 414 such that the front face of the mobile device exhibits a deadfront effect. In some embodiments, display module 414 can be a static display including one or more icons, graphics, and indicators (e.g., a gauge in instrument cluster 150).

Camouflaging (i.e., blending or deadfronting) display unit 10 with a surrounding outer surface can offer numerous advantages. First, camouflaging display unit 10 can deter theft since third-parties may fail to notice that a system (e.g., a vehicle) includes an expensive display. Second, camouflaging display unit 10 can reduce user distraction (e.g., driver distraction) by minimizing the profile of display unit 10. Third, with the knowledge that the additional display units 10 will not cause visual clutter, manufacturers may decide to incorporate extra displays in a system, thereby making the system capable of presenting a greater amount of information. Fourth, systems can draw user attention to a particular display unit 10 (e.g., a gauge in instrument cluster 150) by camouflaging the other display units to alert the user to pressing information (e.g., overspeed).

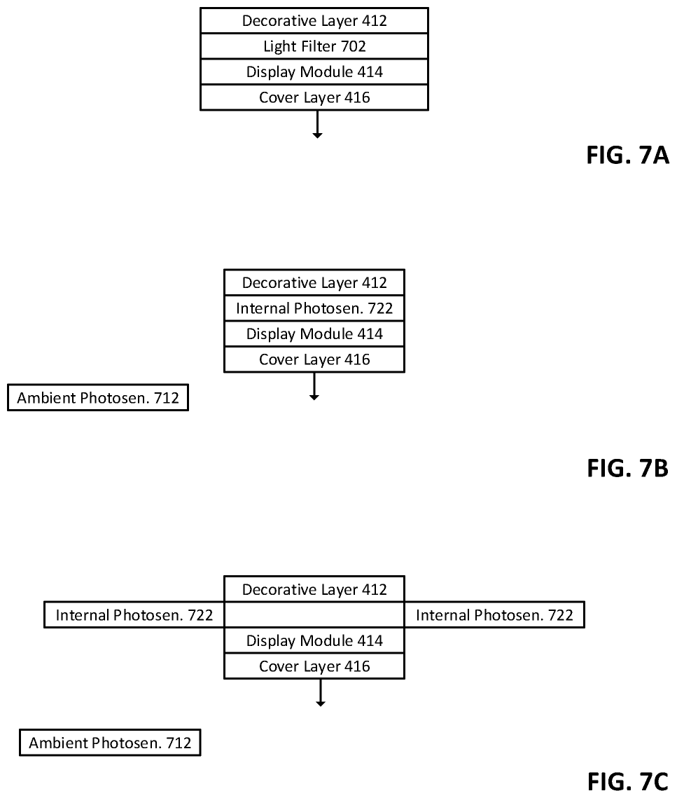

FIGS. 4A-7C schematically illustrate various exemplary features of display unit 10. Any of the features can be combined into a single embodiment. For example, a single vehicle 10 can include each embodiment of display unit 10 disclosed herein. Alternatively, or in addition, a single embodiment of display unit 10 can include any of the features disclosed herein. Put differently, any features described with reference to a particular embodiment of display unit 10 can apply to any other embodiment of display unit 10.

FIGS. 4A-7C are from a top elevational schematic view and generally oriented such that the decorative layer 412 is disposed at the rear of display unit 10 (i.e., the portion of display unit 10 furthest from a viewer) and cover layer 416 is disposed at the front of display unit 10 (i.e., the portion of display unit 10 nearest the viewer). Unless otherwise apparent, the terms “above” and “below” can convey “downstream” and “upstream” respectively. For example, the phrase “the cover layer 416 is above display module 414” can mean that cover layer 416 is downstream of display module 414. The minor arrow in FIGS. 4A-7C shows the direction of light flow out of display unit 10 and toward a user.

Referring to FIG. 4A, display unit 10 can include a decorative layer 412, a display module 414, and a cover layer 416. Decorative layer 412, being upstream of display module 414, can be occluded when display module 414 is active (e.g., in the first mode) and visible when display module 414 is inactive (e.g., in the second mode). Cover layer 416 can include a glass sheet (i.e., panel, layer) protecting display module. Any layer of display unit 10 can be flush with surrounding outer surface 418.

In FIG. 4B, cover layer 416 is flush with outer surface 418 (e.g., outer housing 122, 132, 142, 312, 322—also called “interior vehicle surface”, “body”, “surrounding support”, “panel”, and the like) such display unit 10 appears to be recessed inside of the outer surface 418. In FIG. 4C, decorative layer 412 is flush with outer surface 418 such that display unit 10 appears to project or protrude from outer surface 418. In some embodiments consistent with FIG. 4C, decorative layer 412 can be the portion of outer surface 418 disposed underneath display module 414. Put differently, and as shown in FIG. 4D, display unit 10 can effectively segment outer surface 418 into a first or interior portion 418A located beneath display module 414 and a second or exterior portion 418B at least partially surrounding display module 10.

As further discussed below, decorative layer 412 can include a decorative ink 502 applied to (e.g., painted on) a decorative substrate 504. In the embodiment of FIG. 4D, decorative substrate 504 (not shown for clarity) can be continuous across outer surface 418 such that exterior portion 418B and interior portion 418A are areas defined on a single, integral, and continuous substrate panel.

The application of decorative ink 502 can be the same or can vary between the exterior portion 418B and the interior portion 418A. In some embodiments, a first set of one or more decorative inks are used in the area corresponding to exterior portion 418B while a different second set of one or more decorative inks are used in the area corresponding to interior portion 418A. The variation in coloring between the surface portions 418A, 418B can be to account for the visual effect of the layers above (i.e., downstream of) decorative layer 412 on the appearance of decorative ink 502. For example, one or more glass layers downstream of decorative layers 412 may absorb light, causing the colors in decorative layer 412 to appear less bright or authentic than the colors in the surrounding exterior portion 418B. Therefore, the variation in coloring can be implemented such upon complete assembly, and when the display module is in the inactive mode, the coloring and visual aesthetic of decorative layer 412, after being modified by any subsequent layers, matches the coloring and visual aesthetic of the surrounding exterior portion 418B.

At least the layer of display module 10 flush with outer surface 418 can follow the curvature (if any) of outer surface 418. In FIG. 4E, decorative layer 412 is a separate panel from (i.e., discontinuous with) outer surface 418, but is arranged to observe the curvature of outer surface 418. As a result, decorative layer 412 is flush with outer housing 418. Although not shown, cover layer 416 can be arranged to observe the curvature of outer surface 418, particularly in an embodiment of display module 10 where cover layer 416 is flush with outer surface 418 as shown in FIG. 4B.

Referring to FIG. 5A, decorative layer 412 can include decorative ink 502 applied to (e.g., printed and/or painted on) a decorative substrate 504. Although shown as being upstream, decorative ink 502 can be applied downstream of decorative substrate 504 (i.e., the order of decorative ink 502 and decorative substrate 504 can be reversed). Decorative substrate 504 can be clear (e.g., plastic or glass). Alternatively, decorative substrate 504 can be opaque (e.g., sheet metal). As discussed above, decorative ink 502 and decorative substrate 504 can be aspects of outer surface 418.

Display module 414 can include one or more sealing layers 512 protecting a pixel array 514. Sealing layers 512 can include one or more panels (e.g., glass, plastic, or metal) or adhesive (e.g., adhesive films). Pixel array 514 can include a plurality of pixels arranged in rows and columns. Pixel array 512 can be, for example, a light-emitting diode (LED) pixel array such as an LCD pixel array or an OLED pixel array. Pixel array 514 can include circuitry (e.g., thin-film-transistor (TFT) or in-plane-switching (IPS) circuitry) for controlling the brightness and/or color of individual pixels.

Cover layer 416 can include a cover panel 522 (e.g., cold-formed cover glass) to which a cover coating 524 is applied. Cover panel 522 can have a curvature matching a curvature of outer surface 418, as previously discussed. Cover panel 522 does not need to be made of glass and can instead, be, for example, a layer of plastic. Exemplary features of cover coating 524 are further discussed below. In some embodiments, cover coating 524 can include one or more optical coatings or optical textures which modify light transmittance or reflectance in a way that reduces the visibility of display module 414, which causes an area within display module 414 to have a visual aesthetic similar to the underlying decorative layer 412 and/or similar to the surrounding areas of the assembly outside the area of display module 414 (e.g., outer surface 418).

As previously discussed, decorative layer 412 and/or outer surface 418 can be natural or synthetic. For example, outer surface 418 can include natural wood exhibiting a wood-grain visual aesthetic while decorative layer 412 can include ink (e.g., swirls of tan and dark browns under a glossy coating) simulating the same wood-grain visual aesthetic. In some embodiments, decorative layer 412 and outer surface 418 are both synthetic or both natural. As another example, outer surface 418 and decorative layer 412 can both exhibit a shiny or matte metallic visual aesthetic. One or both of outer surface 418 and decorative layer 412 can naturally exhibit the visual aesthetic by virtue of being formed from metal while one or both of outer surface 418 and decorative layer 412 can simulate such a visual aesthetic. In some embodiments, decorative layer 412 and outer surface 418 naturally exhibit or simulate a leather visual aesthetic or a colored visual aesthetic (e.g., a piano black visual aesthetic).

Cover coating 524 (also called an “optical texture”) can include an optical coating (i.e., treatment) that modifies light transmittance or reflectance in such a way that it reduces the visibility of display module 414 thereby causing an area within display module 414 to have a visual appearance similar to decorative layer 412 and/or similar to the surrounding outer surface 418. When outer surface 418 has a matte visual aesthetic, display unit 10 can have a light scattering optical texture 524 while when outer surface 418 has a glossy visual aesthetic, display unit 10 can have a reflective optical texture 524.

The optical coating can be an anti-reflective coating having a single-surface reflectance less than 1% and a single-surface reflected color value less than ±10 in both a* and b* color coordinates for all incident light angles in the range of 0-80°. Alternatively, or in addition, the optical coating (also called an optical texture) can be a light-scattering surface having a root-mean-squared (RMS) roughness greater than 50 nm, a single-surface specular reflectance less than 2%, and a single-surface diffuse reflectance (diffusing light being light scattered by more than 0.2°) of greater than 0.5%. The optical coating can include a glossy reflective coating having a single surface reflectance of greater than 5% and a single-surface reflected color value less than ±4 in both a* and b* color coordinates for all incident light angles in the range of 0-80°.

As with all embodiments disclosed herein, each layer depicted in FIG. 5A (i.e., layers 502, 504, 512, 514, 522, 524) can be formed from one or more sub-layers. Alternatively, or in addition, supplemental features can be disposed between any two consecutive layers. For example, and as shown in FIGS. 5B and 5C, display module 414 can include one or more polarizing layers 516 (i.e., polarizers) and a capacitive touch sensing layer 518 (i.e., touch sensor).

In the embodiments of FIGS. 5B and 5C, pixel array 514 can be an LCD pixel array and display module 414 can further include a light source 532. In the embodiment of FIG. 5B, the light source 532 can be a backlight 534 disposed upstream of decorative ink 502 while in the embodiment of FIG. 5C, the light source 532 can be an edge light 536 disposed about the periphery of pixel array 514.

FIG. 6A shows an embodiment of display unit 10 having an OLED display module 414 including a transparent TFT substrate 602 (e.g., a panel of glass) hosting electronic TFT circuitry 604. TFT circuitry 604 can be configured to activate individual pixels in pixel array 514. Pixel array 514 can include a cathode layer 612, an emissive layer 614, a conductive layer 616, an anode layer 618, and a substrate layer 620 (e.g., a panel of glass). As with all features disclosed herein, such a configuration is exemplary. As one example, other embodiments of an OLED display module 414 can reverse the order of various layers (e.g., situate anode layer 618 upstream of cathode layer 612).

Referring to FIG. 6B, display module 414 can include a light source 532 (e.g., a projector) mounted external to the remainder of display unit 10 and a transparent layer 624 (e.g., a waveguide formed from one or more layered glass panels) configured to reflect and/or diffract light emitted from light source 532 toward the user. In some embodiments, transparent layer 624 can include cover coating 524 since cover panel 522 can be absent.

When display module 414 is projection-based, transparent layer 624 can include one or more of the following features: First, transparent layer 624 can be configured to selectively reflect certain wavelengths of light, while being transparent to other wavelengths of light (e.g., a multilayer interference mirror tuned to reflect the wavelength of light emitted by light source 532 and to transmit other light spectrum). Second, transparent layer 624 can be configured to selectively scatter certain light wavelengths while being transparent to others, for example, using nanoparticles with sizes selected to more strongly scatter certain wavelengths of light. Third, transparent layer 624 can be configured to convert selected wavelengths of light using, for example, up-converting or down-converting dyes, molecules, or nanoparticles, while remaining transparent to other light wavelengths of light. Fourth, transparent layer 624 can be configured to control the angles of reflectance or scattering from the most forward surface of display unit 10 (e.g., cover panel or if not present, then transparent layer 624) to spread or distribute light over a controlled set of angles. If a narrow angle of view is desired (e.g., display module 414 should only be visible to a driver), then a specular or near-specular reflecting surface with small angles of scattering (or no scattering) can be used. If multiple viewers are desired, then a random scattering surface (e.g., a diffusely reflecting anti-glare surface) may be used. An engineered scattering surface such as diffraction grating or a prismatic surface may also be used to reflect and/or scatter light into a controlled set of angles or towards particular viewers (e.g., towards the driver or a particular passenger). At the same time, the surface can remain transparent at most angles of viewing.

In addition, the light scattering appearance of the surface can be tailored (e.g., via cover coating/optical texture 524) to compliment the appearance of decorative layer 412 (e.g., glossy for a piano black or wood-grain visual aesthetic or diffusely reflecting for a brushed/matte metal surface appearance). Any of the above approaches may be combined. For example, angular control of scattering can be combined with wavelength selective scattering or reflection.

In some embodiments, transparent layer 624 can include light emitting particles embedded within the glass of transparent layer 624 or within an organic, adhesive or polyvinyl butyral (PVB) layer intermediate transparent layer 624 and decorative layer 412 configured to emit light in response to a light source (e.g., a front-projection, a rear, or edge light source). When edge lighting is used, the glass of transparent layer 624 can contain luminescent particles or light extraction features for extracting the internally refracted light in transparent layer 624. Light extraction features can include localized areas of distinct physical or chemical properties, such as locally laser-annealed areas within or on the surface of the transparent layer 624, or molecules or nanoparticles that direct light out of the transparent layer 624.

Display module 414 and/or display unit 10 can have any features of the display (e.g., the transparent OLED display) described in “Efficient transparent small-molecule organic light-emitting devices adopting laminated transparent top electrodes” by Chun-Yu Lin et a. (Oct. 23, 2015), which is hereby incorporated by reference. Display module 414 and/or display unit 10 can have any features of the display (e.g., the transparent OLED display) described in “Transparent organic light emitting devices” by G. Gu et al. (May 6, 1996), which is hereby incorporated by reference. Display module 414 and/or display unit 10 can have any features of the display (e.g., the transparent projection display) described in “Light-efficient augmented reality 3D display using highly transparent retro-reflective screen” by Shoaib R. Soomro et al. (Jul. 24, 2017), which is hereby incorporated by reference. Display module 414 and/or display unit 10 can have any features of the display (e.g., the transparent projection display) described in “See-through multi-projection three-dimensional display using transparent anisotropic diffuser” by Jong-Young Hong et al. (Jun. 15, 2016), which is hereby incorporated by reference.

Referring to FIG. 7A, a light filter 702 including one or more layers, can be disposed between decorative layer 412 and display module 414. Light filter 702 can be configured to selectively admit light flowing from display module 414 toward decorative layer 412. Light filter 702 can be configured to non-selectively admit light flowing from decorative layer 412 toward display module 414. Therefore, light filter 702 can effectively function as a one-way mirror. In some embodiments, light filter 702 can be configured to selectively block red, green, and/or blue spectrum light (while admitting the remaining light spectrum) to discourage light emitted by display module 414 from reaching decorative layer 412, while enabling light emitted by (e.g., reflected off) decorative layer 412 to flow through display module 414.

Light filter 702 can include an active filter as an alternative to, or in addition to, the above described passive filters. For example, light filter 702 include one or more shutters configured to occupy a first position (e.g., a closed position) occluding light communication between decorative layer 412 and display module 414 and to occupy a second position (e.g., an open position) enabling light communication between decorative layer 412 and display module 414. In some embodiments, light filter 702 can include a separate display module configured to be transparent while inactive and opaque (e.g., black) while active. If light filter 702 includes an active filter, then processing system 20 can be configured to control light filter 702 in concert with display module 414. For example, processing system 20 can be configured to cause light filter 702 to occlude light when display module 414 is in the first (e.g., active) mode and to cause light filter 702 to admit light when display module 414 is in the second (e.g., inactive) mode.

Referring to FIGS. 7B and 7C, display unit 10 can include one or more photosensors (i.e., light sensors) configured to capture metrics of light such as brightness or intensity, color, etc. An ambient photosensor 712 can be remote from the remainder of display unit 10 and configured to capture properties of light flowing external to display module 414. For example, ambient photosensor 712 can be disposed on a surface of dashboard 100 directly exposed to light incident flowing through a windshield. Processing system 20 can rely on ambient photosensor 712 to adjust intensity of light output from pixels 514 of display module 414 (e.g., by adjusting the intensity of a light source in the case of a LCD of waveguide display module or the intensity of energy applied to individual pixels in the case of an OLED display module). Ambient photosensor 712 can be mounted within display unit 10.

Display unit 10 can further include one or more internal photosensors 722 disposed downstream of decorative layer 412 and/or upstream of display module 414 configured to measure light flowing from decorative layer 412 toward display module 414 and/or light flowing from display module 414 toward decorative layer 412. In FIG. 7B, the one or more internal photosensors 722 can be transparent and/or mounted to a transparent substrate (e.g., TFT substrate 602) while in FIG. 7C, the one or more internal photosensors 722 are mounted at the periphery of display unit 10 to avoid interference.

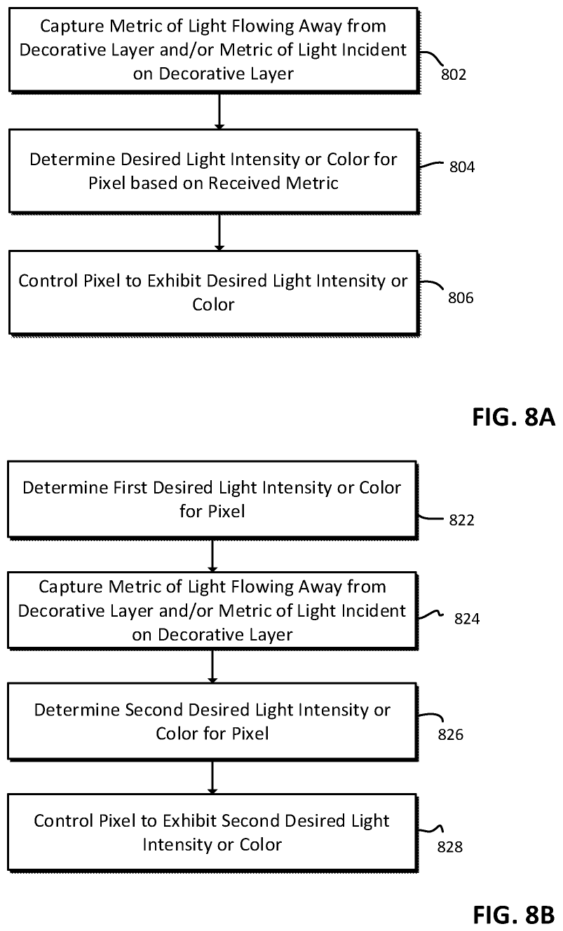

FIG. 8A presents a method of controlling display unit 10 (e.g., via processing system 20) based on metrics captured by ambient and/or internal photosensors 712, 722. In some embodiments, display unit 10 can control the pixels 514 of display module 414 to cancel interference with light flowing from decorative layer 412. At block 802, processing system 20 can receive a metric of light flowing away from decorative layer 412 and toward one of the pixels 514 (i.e., toward pixel layer 514) and/or a metric of light incident on the decorative layer 412. The one or more internal photosensors 722 can capture the metric, which can account for light brightness or intensity and/or light color.

At block 804, processing system 20 can determine, based on the received metric, a desired light intensity or color (i.e., at least one light property) for the at least one pixel 514. At block 806, processing system 20 can control the at least one pixel 514 (i.e., control the display module 414) based on the determined light intensity or color. For example, processing system 20 can control the at least one pixel 514 to compensate for the effect of light emitted by (e.g., reflected from) decorative layer 412. Therefore, during block 804, processing system 20 can determine the desired light intensity or color for the at least one pixel 514 based on the received metric and a graphic intended for presentation by the at least one pixel 514.

FIG. 8B presents another method of controlling display unit 10 (e.g., via processing system 20). At block 822, processing system 20 can determine, based on a graphic intended for presentation via display module 414, a first desired light intensity or color (i.e., light property) for one or more pixels 514. At block 824, processing system 20 can receive, from the one or more internal photosensors 722, a metric of light flowing away from decorative layer 412 and toward the one or more pixels 514 and/or a metric of light incident on decorative layer 412.

At block 826, processing system 20 can determine, based on the metric and the first desired light intensity or color, a second desired light intensity or color for the one or more pixels 514. The second desired light intensity or color can be configured to compensate for light flowing from decorative layer 412 such that when light from the one or more pixels 514 combines with the light flowing from decorative layer 412, the net effect will be light having the first desired intensity or color.

For example, if light flowing from decorative layer 412 toward pixel array 514 is blue, and the graphic intended for display (e.g., the first desired light intensity and/or color) is purple, then processing system 20 can cause pixel array 514 to emit red light with the expectation that the red light will mix with the blue light flowing from decorative layer 412 to produce the intended purple light. As another example, if the first desired light intensity is high and the capture metric is a low light intensity, then processing system 20 can cause the one or more pixels 514 to emit high intensity light while if the first desired light intensity is high and the captured metric is a high light intensity, then processing system 20 can cause the one or more pixels 514 to emit low intensity light. As a result, processing system 20 can be configured to determine the second desired light intensity or color based on a difference between the first metric and the first desired light intensity or color.

During block 826, processing system 20 can determine the second desired light intensity or color based on the metric captured by the one or more internal photosensors 722, the first desired light intensity or color, and a metric of ambient light captured by the one or more ambient photosensors 712. At block 828, processing system 20 can cause the one or more pixels 514 to emit the second desired light intensity or color.

Processing system 20 can perform the method of FIGS. 8A and 8B for every pixel in array 514. Processing system 20 can repeat the method of FIGS. 8A and 8B for each graphic to be presented on display unit 414 (e.g., for each frame of a video).

Referring to FIG. 9, processing system 20 can include one or more processors 21, memory 22, one or more input/output devices 23, one or more sensors 24, one or more user interfaces 25, and one or more actuators 26. Processing system 20 can include display unit 10 and be configured to control any component of display unit 10. Processing system 20 can be distributed. For example, some elements of processing system 20 can be disposed within display unit 10 (e.g., TFT circuitry 604 and pixel array 514). Other elements of processing system 20 can be disposed in another location (e.g., at a vehicle central controller, at a remote server, at a mobile device central controller, etc.).

Processors 21 may include one or more distinct processors, each having one or more cores. Each of the distinct processors may have the same or different structure. Processors 21 may include one or more central processing units (CPUs), one or more graphics processing units (GPUs), circuitry (e.g., application specific integrated circuits (ASICs)), digital signal processors (DSPs), and the like. Processors 21 may be mounted on a common substrate or to different substrates.

Processors 21 are configured to perform a certain function, method, or operation at least when one of the one or more of the distinct processors is capable of executing code, stored on memory 22 embodying the function, method, or operation. Processors 21 may be configured to perform any and all functions, methods, and operations disclosed herein.

For example, when the present disclosure states that processing system 20 performs/may perform task “X”, such a statement conveys that processing system 20 may be configured to perform task “X”. Similarly, when the present disclosure states that a device performs/may perform task “X”, such a statement conveys that the processing system 20 of the respective may be configured to perform task “X”. Processing system 20 is configured to perform a function, method, or operation at least when processors 21 are configured to do the same.

Memory 22 may include volatile memory, non-volatile memory, and any other medium capable of storing data. Each of the volatile memory, non-volatile memory, and any other type of memory may include multiple different memory devices, located at multiple distinct locations and each having a different structure. Examples of memory 22 include a non-transitory computer-readable media such as RAM, ROM, flash memory, EEPROM, any kind of optical storage disk such as a DVD, a Blu-Ray® disc, magnetic storage, holographic storage, an HDD, an SSD, any medium that may be used to store program code in the form of instructions or data structures, and the like. Any and all of the methods, functions, and operations described in the present application may be fully embodied in the form of tangible and/or non-transitory machine-readable code saved in memory 22.

Input-output devices 23 may include any component for trafficking data such as ports, antennas (i.e., transceivers), printed conductive paths, and the like. Input-output devices 23 may enable wired communication via USB®, DisplayPort®, HDMI®, Ethernet, and the like. Input-output devices 23 may enable electronic, optical, magnetic, and holographic, communication with suitable memory 23. Input-output devices 23 may enable wireless communication via WiFi®, Bluetooth®, cellular (e.g., LTE®, CDMA®, GSM®, WiMax®, NFC®), GPS, and the like. Input-output devices 23 may include wired and/or wireless communication pathways.

Sensors 24 may capture physical measurements of environment and report the same to processors 21. Examples of sensors 24 include photosensors. User interface 25 may include displays (e.g., LED touchscreens (e.g., OLED touchscreens), physical buttons, speakers, microphones, keyboards, and the like. Actuators 26 may enable processors 21 to control mechanical forces. For example, actuators may be electronically controllable motors (e.g., motors for when light filter 702 operates as a shutter).

Aspect (1) of this disclosure pertains to an assembly comprising: a decorative layer comprising a substrate panel; a transparent display module mounted to the decorative layer and comprising a glass substrate, the assembly being configured such that when the display module is in an inactive state, the decorative layer is visible through the glass substrate; a cover glass mounted to the display module; wherein at least one of the cover glass and the glass substrate comprises an optical coating or texture that modifies light transmittance and/or light reflectance in a manner that reduces visibility of the display module, causing an area within the display module to have an appearance that is similar to the decorative layer.

Aspect (2) of this disclosure pertains to the assembly of Aspect (1), wherein the optical coating is an anti-reflective coating having a single-surface reflectance less than 1% and a single-surface reflected color value that is less than +/−10 in both a* and b* color coordinates for all incident light angles from 0-80°.

Aspect (3) of this disclosure pertains to the assembly of Aspect (1) or Aspect (2), wherein the optical texture is a light-scattering surface having an RMS roughness greater than 50nm, a single-surface specular reflectance less than 2%, and single-surface diffuse reflectance of greater than 0.5%, where diffuse is defined as light scattered by more than 0.2°.

Aspect (4) of this disclosure pertains to the assembly of any one of Aspects (1) through (3), wherein the optical coating comprises a glossy reflective coating having a single surface reflectance of greater than 5% and a single-surface reflected color value that is less than +/−4 in both a* and b* color coordinates for all incident light angles from 0-80°.

Aspect (5) of this disclosure pertains to the assembly of any one of Aspects (1) through (4), wherein the decorative layer has a visual aesthetic selected from the group consisting of a metallic surface, a leather surface, a wood grain surface, and a black surface.

Aspect (6) of this disclosure pertains to an assembly comprising: a decorative layer comprising ink applied to a substrate; a transparent display module mounted to the decorative layer and comprising an array of pixels and an outer cover glass, the pixel array being disposed between the decorative layer and the cover glass; wherein the assembly is configured such that when the display module is in a first mode, the decorative layer is visible from the cover glass and through the pixel array.

Aspect (7) of this disclosure pertains to the assembly of Aspect (6), wherein the cover glass comprises at least one of: an anti-reflective optical coating having a single-surface reflectance less than 1% and a single-surface reflected color value that is less than +/−10 in both a* and b* color coordinates for all incident light angles from 0-80°; a light scattering optical texture having an RMS roughness greater than 50 nm, a single-surface specular reflectance less than 2%, and single-surface diffuse reflectance of greater than 0.5%, where diffuse is defined as light scattered by more than 0.2°; and an optical coating comprising a glossy reflective coating having a single surface reflectance of greater than 5% and a single-surface reflected color value that is less than +/−4 in both a* and b* color coordinates for all incident light angles from 0-80°.

Aspect (8) of this disclosure pertains to the assembly of Aspect (6) or Aspect (7), where the decorative layer has a visual aesthetic selected from the group consisting of a metallic surface, a leather surface, and a wood grain surface.

Aspect (9) of this disclosure pertains to the assembly of any one of Aspects (6) through (8), wherein the decorative layer substrate is an outer panel of a vehicle dashboard.

Aspect (10) of this disclosure pertains to the assembly of Aspect (9), wherein the display module is mounted over an arced portion of the outer dashboard panel.

Aspect (11) of this disclosure pertains to the assembly of any one of Aspects (6) through (10), wherein the cover glass is in a cold-formed configuration.

Aspect (12) of this disclosure pertains to the assembly of any one of Aspects (9) through (11), wherein the dashboard panel defines an external surface area at least partially surrounding the display module and an internal surface area covered by the display module, the external and internal surface areas having matching visual aesthetics.

Aspect (13) of this disclosure pertains to the assembly of any one of Aspects (6) through (12), wherein (a) the cover glass comprises a light scattering optical texture and the decorative layer exhibits a brushed metal visual aesthetic or (b) the cover glass comprises a glossy reflective coating and the decorative layer exhibits a wood grain visual aesthetic.

Aspect (14) of this disclosure pertains to the assembly of any one of Aspects (6) through (13), configured such that when the display module is in a second mode, light emitted from the pixels occludes the decorative layer.

Aspect (15) of this disclosure pertains to the assembly of any one of Aspects (6) through (14), comprising a light filter comprising one or more layers disposed between the decorative layer and the pixel array, the light filter being configured to block at least one of red, green, and blue spectrum light to prevent light emitted by the pixels from reaching the decorative layer.

Aspect (16) of this disclosure pertains to the assembly of any one of Aspects (6) through (15), wherein the light filter is configured to transmit light flowing from the decorative layer toward the pixel array while reflecting light flowing from the pixel array toward the decorative layer.

Aspect (17) of this disclosure pertains to the assembly of any one of Aspects (6) through (16), comprising one or more processors configured to: receive, from a photosensor, a metric of light flowing away from the decorative layer and toward at least one of the pixels or a metric of light incident on the decorative layer; determine, based on the received metric, a desired light intensity or color for the at least one pixel; and cause the at least one pixel to emit the desired light intensity or color.

Aspect (18) of this disclosure pertains to the assembly of any one of Aspects (6) through (17), comprising one or more processors configured to: determine, based on a graphic for display, a first desired light intensity or color for at least one of the pixels; receive, from a first photosensor, a first metric of light flowing away from the decorative layer and toward the at least one pixel or a metric of light incident on the decorative layer; and determine, based on the first metric and the first desired light intensity or color, a second desired light intensity or color for the at least one pixel; cause the at least one pixel to emit the second desired light intensity or color.

Aspect (19) of this disclosure pertains to the assembly of Aspect (18), wherein the one or more processors are configured to determine the second desired light intensity or color based on a difference between the first metric and the first desired light intensity or color.

Aspect (20) pertains to a vehicle comprising: a transparent display module comprising an array of pixels and a glass substrate; a decorative layer mounted to the display module and comprising ink applied to a substrate, the decorative layer being disposed underneath the pixel array; wherein the vehicle is configured such that when the display module is in a first mode, the decorative layer is visible through the glass substrate of the display module and through the pixel array.

Aspect (21) of this disclosure pertains to the vehicle of Aspect (20), wherein the decorative layer and an outer surface of the vehicle immediately adjacent the display module have matching visual aesthetics.

Aspect (22) of this disclosure pertains to the vehicle of Aspect (21), wherein the decorative layer and the outer vehicle surface both have a metallic, a wood grain, or a leather visual aesthetic.

Aspect (23) of this disclosure pertains to the vehicle of any one of Aspects (20) through (22) configured such that when the display module is in a second state, light emitted from the pixels occludes the decorative layer.

Aspect (24) of this disclosure pertains to the vehicle of any one of Aspects (20) through (23), comprising one or more processors configured to: receive, from a photo sensor, a metric of light flowing away from the decorative layer and toward at least one of the pixels; determine, based on the received metric, a desired light intensity or color for the at least one pixel; and cause the at least one pixel to emit the desired light intensity or color.

1. An assembly comprising:
a decorative layer comprising a substrate panel;
a transparent display module mounted to the decorative layer and comprising a glass substrate, the assembly being configured such that when the display module is in an inactive state, the decorative layer is visible through the glass substrate;
a cover glass mounted to the display module;
wherein at least one of the cover glass and the glass substrate comprises an optical coating or texture that modifies light transmittance and/or light reflectance in a manner that reduces visibility of the display module, causing an area within the display module to have an appearance that is similar to the decorative layer.

2. The assembly of claim 1, wherein the optical coating comprises one or both of an anti-reflective coating having a single-surface reflectance less than 1% and a single-surface reflected color value that is less than +/−10 in both a* and b* color coordinates for all incident light angles from 0-80° and a glossy reflective coating having a single surface reflectance of greater than 5% and a single-surface reflected color value that is less than +/−4 in both a* and b* color coordinates for all incident light angles from 0-80°, and
wherein the optical texture is a light-scattering surface having an RMS roughness greater than 50 nm, a single-surface specular reflectance less than 2%, and single-surface diffuse reflectance of greater than 0.5%, where diffuse is defined as light scattered by more than 0.2°.

3. (canceled)

4. (canceled)

5. The assembly of claim 1, wherein the decorative layer has a visual aesthetic selected from the group consisting of a metallic surface, a leather surface, a wood grain surface, and a black surface.

6. An assembly comprising:
a decorative layer comprising ink applied to a substrate;
a transparent display module mounted to the decorative layer and comprising an array of pixels and an outer cover glass, the pixel array being disposed between the decorative layer and the cover glass;
wherein the assembly is configured such that when the display module is in a first mode, the decorative layer is visible from the cover glass and through the pixel array.

7. The assembly of claim 6, wherein the cover glass comprises at least one of:
an anti-reflective optical coating having a single-surface reflectance less than 1% and a single-surface reflected color value that is less than +/−10 in both a* and b* color coordinates for all incident light angles from 0-80°;
a light scattering optical texture having an RMS roughness greater than 50 nm, a single-surface specular reflectance less than 2%, and single-surface diffuse reflectance of greater than 0.5%, where diffuse is defined as light scattered by more than 0.2°; and
an optical coating comprising a glossy reflective coating having a single surface reflectance of greater than 5% and a single-surface reflected color value that is less than +/−4 in both a* and b* color coordinates for all incident light angles from 0-80°.

8. The assembly of claim 6, where the decorative layer has a visual aesthetic selected from the group consisting of a metallic surface, a leather surface, and a wood grain surface.

9. The assembly of claim 6, wherein the decorative layer substrate is an outer panel of a vehicle dashboard.

10. The assembly of claim 9, wherein the display module is mounted over an arced portion of the outer dashboard panel.

11. The assembly of claim 6, wherein the cover glass is in a cold-formed configuration.

12. The assembly of claim 9, wherein the dashboard panel defines an external surface area at least partially surrounding the display module and an internal surface area covered by the display module, the external and internal surface areas having matching visual aesthetics.

13. The assembly of claim 6, wherein (a) the cover glass comprises a light scattering optical texture and the decorative layer exhibits a brushed metal visual aesthetic or (b) the cover glass comprises a glossy reflective coating and the decorative layer exhibits a wood grain visual aesthetic.

14. The assembly of claim 6, configured such that when the display module is in a second mode, light emitted from the pixels occludes the decorative layer.

15. The assembly of claim 6, comprising a light filter comprising one or more layers disposed between the decorative layer and the pixel array, the light filter being configured to block at least one of red, green, and blue spectrum light to prevent light emitted by the pixels from reaching the decorative layer.

16. The assembly of claim 15, wherein the light filter is configured to transmit light flowing from the decorative layer toward the pixel array while reflecting light flowing from the pixel array toward the decorative layer.

17. The assembly of claim 6 comprising one or more processors configured to:
receive, from a photosensor, a metric of light flowing away from the decorative layer and toward at least one of the pixels or a metric of light incident on the decorative layer;
determine, based on the received metric, a desired light intensity or color for the at least one pixel; and
cause the at least one pixel to emit the desired light intensity or color.

18. The assembly of claim 6 comprising one or more processors configured to:
determine, based on a graphic for display, a first desired light intensity or color for at least one of the pixels;
receive, from a first photosensor, a first metric of light flowing away from the decorative layer and toward the at least one pixel or a metric of light incident on the decorative layer; and
determine, based on the first metric and the first desired light intensity or color, a second desired light intensity or color for the at least one pixel;
cause the at least one pixel to emit the second desired light intensity or color.

19. The assembly of claim 18, wherein the one or more processors are configured to determine the second desired light intensity or color based on a difference between the first metric and the first desired light intensity or color.

20. A vehicle comprising:
a transparent display module comprising an array of pixels and a glass substrate;
a decorative layer mounted to the display module and comprising ink applied to a substrate, the decorative layer being disposed underneath the pixel array;
wherein the vehicle is configured such that when the display module is in a first mode, the decorative layer is visible through the glass substrate of the display module and through the pixel array.

21. (canceled)

22. (canceled)

23. The vehicle of claim 20, configured such that when the display module is in a second state, light emitted from the pixels occludes the decorative layer.

24. The vehicle of claim 20, comprising one or more processors configured to:
receive, from a photosensor, a metric of light flowing away from the decorative layer and toward at least one of the pixels;
determine, based on the received metric, a desired light intensity or color for the at least one pixel; and
cause the at least one pixel to emit the desired light intensity or color.
